(19) United States
(12) Patent Application Publication
(10) Pub. No.: US 2026/0062991 A1
(43) Pub. Date: Mar. 5, 2026

(54) LED WINDOW BLIND ASSEMBLY

(71) Applicant: Jerome Anderson, Richmond, VA (US)

(72) Inventor: Jerome Anderson, Richmond, VA (US)

(21) Appl. No.: 18/817,974

(22) Filed: Aug. 28, 2024

(51) Int. Cl. E06B 9/262; E06B 9/24

(52) U.S. Cl. CPC E06B 9/262; E06B 2009/247; E06B 2009/2625

(57) ABSTRACT

A light emitting diode (LED) window blind assembly, including a mounting bracket to attach to an external object, and a window blind main body attached to the mounting bracket at a top portion thereof, the window blind main body including a plurality of blinds, and a plurality of light emitting diodes (LEDs) disposed throughout the plurality of blinds to display an image on the blinds.

### BACKGROUND

### 1. Field

The present general inventive concept relates generally to a window blind assembly, and particularly, to an LED window blind assembly.

### 2. Description of the Related Art

In today's fast-paced world, stress and anxiety are common, and finding a way to escape such feelings can be difficult.

When it comes to home decor, there is always an interest in defining a serene space by use of accessories and decorating tips, yet, there is a lack of creative options related to window treatments.

Therefore, there is a need for a window blind that can offer a user a customizable display.

### SUMMARY

The present general inventive concept provides an LED window blind assembly.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a light emitting diode (LED) window blind assembly, including a mounting bracket to attach to an external object, and a window blind main body attached to the mounting bracket at a top portion thereof, the window blind main body including a plurality of blinds, and a plurality of light emitting diodes (LEDs) disposed throughout the plurality of blinds to display an image on the blinds.

The mounting bracket may include a central processing unit (CPU) to communicate with the plurality of LEDs, such that the plurality of LEDs may be programmable to display the image based on a user's selection.

The CPU may be designed to wirelessly communicate with a mobile device to allow the user to select the image to be displayed on the plurality of LEDs.

The image may be at least one of a still image and a moving image.

The mounting bracket may further include a speaker disposed within the mounting bracket to output at least one of a sound and music based the user's preference.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an angled perspective view of an LED window blind assembly according to an exemplary embodiment of the present general inventive concept; and

FIG. 2 illustrates an angled perspective view of an LED window blind assembly according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,”“adjacent”versus “directly adjacent,”etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Mobile Device 10
LED Window Blind Assembly 100
Mounting Bracket 110
Central Processing Unit (CPU) 111
Speaker 112
Power Button 113
Power Cable 114
Window Blind Main Body 120
Blinds 121
Light Emitting Diodes (LEDs) 122
End Plate 130
LED Window Blind Assembly 200
Mounting Bracket 210
Central Processing Unit (CPU) 211
Speaker 212
Power Button 213
Power Cable 214
Window Blind Main Body 220
Blinds 221
Light Emitting Diodes (LEDs) 222
Power Distribution Cords 223
End Plate 230

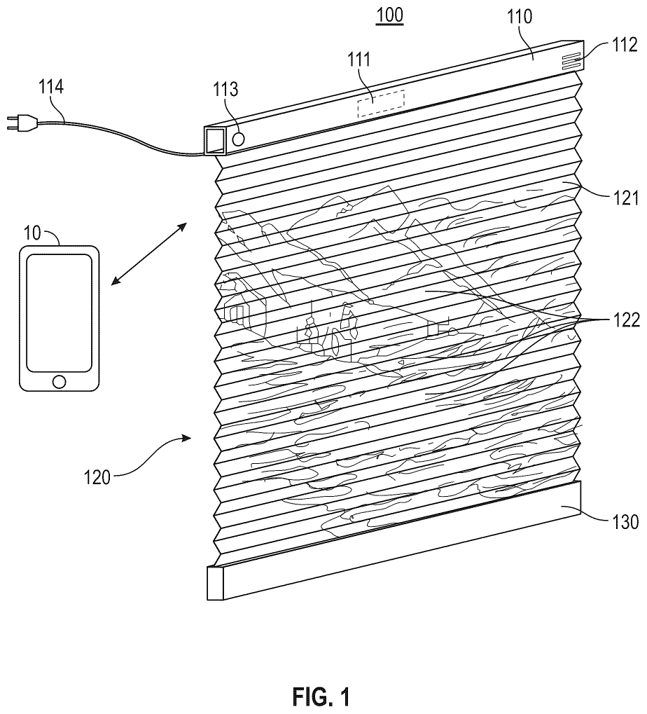

FIG. 1 illustrates an angled perspective view of an LED window blind assembly 100 according to an exemplary embodiment of the present general inventive concept.

The LED window blind assembly 100, and all components therein and/or connected thereto, may be constructed from at least one of metal, plastic, stone, ceramics, wood, silicone, paper, cloth, circuitry, leather, memory foam, latex, diodes, and rubber, etc., but is not limited thereto, and can be constructed from any material known to one of ordinary skill in the art.

Referring to FIG. 1, the LED window blind assembly 100 may include a mounting bracket 110, a window blind main body 120, and an end plate 130, but is not limited thereto.

The mounting bracket 110 may be disposed at a top portion of the LED window blind assembly 100, and may be designed to allow a user to mount the LED window blind assembly 100 to a wall, preferably to cover a window, but is not limited thereto, and may be mountable to any wall or surface.

The mounting bracket 110 may include a central processing unit (CPU) 111, a speaker 112, a power button 113, and a power cable 114, but is not limited thereto.

The window blind main body 120 may be connected to the mounting bracket 110 at a top portion thereof, and may be connected to the end plate 130 at a bottom portion thereof.

The window blind main body 120 may include blinds 121 and a plurality of light emitting diodes (LEDs) 122, but is not limited thereto.

Referring to FIG. 1, the blinds 121 may take a form of accordion-type blinds, but alternatively, may take a form of roller blinds, pleated blinds, panel blinds, etc.

The plurality of light emitting diodes (LEDs) 122 may be provided and dispersed throughout the blinds 122, and may be any type of LEDs, including standard LEDs, organic LEDs (OLEDs), etc., but are not limited thereto, and may be any type of light source that allows a picture to be displayed on the blinds 121.

The CPU 111 may be disposed within the mounting bracket 110, and may communicate with a mobile device 10, the speaker 112, which is also disposed within the mounting bracket 110, and the plurality of LEDs 122.

The power button 113 may be disposed on an outer surface of the mounting bracket 110, and may be pressed to power-on and power-off the LED window blind assembly 100 (i.e., the CPU 111, the speaker 121, and the plurality of LEDs 122).

The power cable 114 may be provided to be connected to the components disposed within the mounting bracket 110, such that the power cable 114 may be plugged into an electrical socket and/or other power source to provide power to the electrical components within the LED window blind assembly 100.

The CPU 111 may include electronic circuitry to carry out instructions of a computer program by performing basic arithmetic, logical, control and input/output (I/O) operations specified by the instructions. The CPU 111 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 111 may also include a microprocessor and a microcontroller. The transmitter CPU 111 may be a local computer device, a remote server, or cloud computing device.

The CPU 111 may also include a storage unit, a random access memory (RAM), a read-only memory (ROM), a hard disk, a flash drive, a database connected to the Internet, cloud-based storage, Internet-based storage, or any other type of storage unit.

The CPU 111 may access the Internet via an internal communication unit to allow the CPU 111 to access a website, and/or may allow for communication with a mobile application and/or a software application. For ease of description, the mobile and/or the software application will be hereinafter referred to as an app. The app may be downloaded from the Internet to be stored on the storage unit of the CPU 111.

The CPU 111 may also have a global positioning service (GPS) device installed therein, to allow the CPU 111 to be located via a GPS signal.

Thus, the CPU 111 may provide communication between the LED window blind assembly 100 and the mobile device 10 (via WIFI, BLUETOOTH, or any other type of communication method), which may be running the app thereon to allow the user to select from different pictures, videos, sounds, and music that may be displayed on the blinds 121 and/or played via the speaker 112.

Specifically, the plurality of LEDs 122 may be controlled by the CPU 111 to display a user-selected picture and/or video, thus providing a particular scene on the blinds 121. For example, if it is raining outside, the blinds 121, via the plurality of LEDs 122, may display a sunny beach picture and/or video.

Furthermore, the CPU 111 may control the speaker 112 to play an audio file that corresponds to the scene displayed on the blinds 121, or alternatively, can play any audio file selected by the user.

Again, as an example, if a beach scene video is selected to be displayed by the user on the blinds 121, the speaker 112 may emit sounds such as ocean waves crashing to correspond to the waves displayed on the blinds 121. Alternatively, the user can simply choose music that is relatable to a beach or vacation setting, such as Calypso music, Bob Marley music, etc.

Thus, the LED window blind assembly 100 may provide a tranquil experience for the user, instead of subjecting the user to the reality of the thunderstorm outside.

The end plate 130 may be disposed at a bottom portion of the LED window blind assembly 100 such that it is connected to a bottom portion of the window blind main body 120, and may act as a weight and stabilizer to keep the window blind main body 120 extended and motionless.

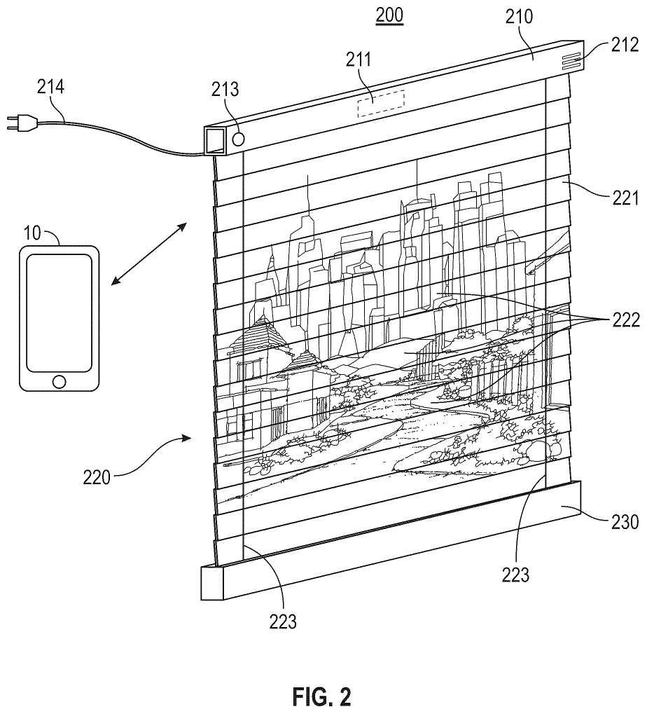

FIG. 2 illustrates an angled perspective view of an LED window blind assembly 200 according to another exemplary embodiment of the present general inventive concept.

The LED window blind assembly 200, and all components therein and/or connected thereto, may be constructed from at least one of metal, plastic, stone, ceramics, wood, silicone, paper, cloth, circuitry, leather, memory foam, latex, diodes, and rubber, etc., but is not limited thereto, and can be constructed from any material known to one of ordinary skill in the art.

Referring to FIG. 2, the LED window blind assembly 200 may include a mounting bracket 210, a window blind main body 220, and an end plate 230, but is not limited thereto.

The mounting bracket 210 may be disposed at a top portion of the LED window blind assembly 200, and may be designed to allow a user to mount the LED window blind assembly 200 to a wall, preferably to cover a window, but is not limited thereto, and may be mountable to any wall or surface.

The mounting bracket 210 may include a central processing unit (CPU) 211, a speaker 212, a power button 213, and a power cable 214, but is not limited thereto.

The window blind main body 220 may be connected to the mounting bracket 210 at a top portion thereof, and may be connected to the end plate 230 at a bottom portion thereof.

The window blind main body 120 may include blinds 221, a plurality of light emitting diodes (LEDs) 222, and power distribution cords 223, but is not limited thereto.

The plurality of light emitting diodes (LEDs) 222 may be provided and dispersed throughout the blinds 222, and may be any type of LEDs, including standard LEDs, organic LEDs (OLEDs), etc., but are not limited thereto, and may be any type of light source that allows a picture to be displayed on the blinds 221.

Referring to FIG. 2, the blinds 221 may take a form of Venetian blinds, but alternatively, may take a form of roller blinds, pleated blinds, panel blinds, etc. As such, each of the blinds 221 is separated from one another, but the blinds 221 are connected to the power distribution cords 223 that are disposed at side portions of the blinds 221, and which are connected to the CPU 211 to allow the CPU 211 to control the plurality of LEDs 222 that are dispersed throughout the blinds 221.

The CPU 211 may be disposed within the mounting bracket 210, and may communicate with a mobile device 10, the speaker 212, which is also disposed within the mounting bracket 210, and the plurality of LEDs 222 (i.e., via the power distribution cords 223).

The power button 213 may be disposed on an outer surface of the mounting bracket 210, and may be pressed to power-on and power-off the LED window blind assembly 200 (i.e., the CPU 211, the speaker 221, and the plurality of LEDs 222).

The power cable 214 may be provided to be connected to the components disposed within the mounting bracket 210, such that the power cable 214 may be plugged into an electrical socket and/or other power source to provide power to the electrical components within the LED window blind assembly 200.

The CPU 211 may include electronic circuitry to carry out instructions of a computer program by performing basic arithmetic, logical, control and input/output (I/O) operations specified by the instructions. The CPU 211 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 211 may also include a microprocessor and a microcontroller. The transmitter CPU 211 may be a local computer device, a remote server, or cloud computing device.

The CPU 211 may also include a storage unit, a random access memory (RAM), a read-only memory (ROM), a hard disk, a flash drive, a database connected to the Internet, cloud-based storage, Internet-based storage, or any other type of storage unit.

The CPU 211 may access the Internet via an internal communication unit to allow the CPU 211 to access a website, and/or may allow for communication with a mobile application and/or a software application. For ease of description, the mobile and/or the software application will be hereinafter referred to as an app. The app may be downloaded from the Internet to be stored on the storage unit of the CPU 211.

The CPU 211 may also have a global positioning service (GPS) device installed therein, to allow the CPU 211 to be located via a GPS signal.

Thus, the CPU 211 may provide communication between the LED window blind assembly 200 and the mobile device 10 (via WIFI, BLUETOOTH, or any other type of communication method), which may be running the app thereon to allow the user to select from different pictures, videos, sounds, and music that may be displayed on the blinds 221 and/or played via the speaker 212.

Specifically, the plurality of LEDs 222 may be controlled by the CPU 211 to display a user-selected picture and/or video, thus providing a particular scene on the blinds 221. For example, if it is raining outside, the blinds 221, via the plurality of LEDs 222, may display a sunny beach picture and/or video.

Furthermore, the CPU 211 may control the speaker 212 to play an audio file that corresponds to the scene displayed on the blinds 221, or alternatively, can play any audio file selected by the user.

Again, as an example, if a beach scene video is selected to be displayed by the user on the blinds 221, the speaker 212 may emit sounds such as ocean waves crashing to correspond to the waves displayed on the blinds 221. Alternatively, the user can simply choose music that is relatable to a beach or vacation setting, such as Calypso music, Bob Marley music, etc.

Thus, the LED window blind assembly 200 may provide a tranquil experience for the user, instead of subjecting the user to the reality of the thunderstorm outside.

The end plate 230 may be disposed at a bottom portion of the LED window blind assembly 200 such that it is connected to a bottom portion of the window blind main body 220, and may act as a weight and stabilizer to keep the window blind main body 120 extended and motionless.

The present general inventive concept may include a light emitting diode (LED) window blind assembly 100, including a mounting bracket 110 to attach to an external object, and a window blind main body 120 attached to the mounting bracket at a top portion thereof, the window blind main body 120 including a plurality of blinds 121, and a plurality of light emitting diodes (LEDs) 122 disposed throughout the plurality of blinds to display an image on the blinds.

The mounting bracket 100 may include a central processing unit (CPU) 111 to communicate with the plurality of LEDs 122, such that the plurality of LEDs 122 are programmable to display the image based on a user's selection.

The CPU 111 may be designed to wirelessly communicate with a mobile device 10 to allow the user to select the image to be displayed on the plurality of LEDs 122.

The image may be at least one of a still image and a moving image.

The mounting bracket 100 may further include a speaker 112 disposed within the mounting bracket 100 to output at least one of a sound and music based the user's preference.

Accordingly, light emitting diode (LED) window blind assembly 100 may include the plurality of LEDs 122 arranged on the plurality of blinds 121 to create a customizable display for the user.

A main purpose of the present general inventive concept is to provide users with window treatments possessing a high-definition pixel screen and Bluetooth connectivity, designed to elevate any environment and enhance moods via visual and audio features. Ingenious and practical, the present general inventive concept offers a modern window dressing that allows users to instantly transport themselves to a new environment through cutting-edge imagery. Expanding on the initial design of traditional blinds, the present general inventive concept introduces a novel high-definition pixel screen with an LED display that permits users to showcase a variety of high-definition themes and backgrounds on the blinds, effectively, personalizing their environment. Users simply download the desired features and backgrounds from the product's complimentary app and choose from a wide variety of themes. To further enhance the transformative experience, the present general inventive concept features a speaker which enables users to listen to their favorite soothing sounds while enjoying their chosen views. With high-definition themes and lifelike sound effects, users will get to experience a realistic representation of different spaces, cities, and environments allowing them to escape from the stresses of everyday life while in the comfort of their home. As a result, the present general inventive concept may prove to be essential in the novelty/electronics industry.

The present general inventive concept is the only product of its kind that provides users with a customizable and immersive experience that promotes relaxation, inspiration, and well-being through LED blinds. This unprecedented product is uniquely designed with diverse virtual display features that are categorized via a mobile application. The present general inventive concept is easy to install with the blind mounting bracket and employ a high-definition pixel screen that can be utilized on mini, pleated, vertical, venetian, roller, panel, etc. window decor options, in addition to, possessing Bluetooth connectivity for audio enjoyment.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A light emitting diode (LED) window blind assembly,
comprising: a mounting bracket to attach to an external object; and
a window blind main body attached to the mounting bracket at a top portion thereof, the window blind main body comprising:
a plurality of blinds, and
a plurality of light emitting diodes (LEDs) disposed throughout the plurality of blinds to display an image on the blinds.

2. The LED window blind assembly of claim 1, wherein the mounting bracket 100 comprises:
a central processing unit (CPU) to communicate with the plurality of LEDs, such that the plurality of LEDs are programmable to display the image based on a user's selection.

3. The LED window blind assembly of claim 2, wherein the CPU is designed to wirelessly communicate with a mobile device to allow the user to select the image to be displayed on the plurality of LEDs.

4. The LED window blind assembly of claim 2, wherein the image is at least one of a still image and a moving image.

5. The LED window blind assembly of claim 2, wherein the mounting bracket further comprises:
a speaker disposed within the mounting bracket to output at least one of a sound and music based the user's preference.
